(19) United States
(12) Patent Application Publication
(10) Pub. No.: US 2002/0116688 A1
(43) Pub. Date: Aug. 22, 2002

(54) Mapping device with logic consolidation function, mapping method, and program therefor

(75) Inventor: Masayuki Yuguchi, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/075,302

(22) Filed: Feb. 15, 2002

(30) Foreign Application Priority Data
Feb. 16, 2001 (JP) 2001-040664

(51) Int. Cl. G06F 17/50

(52) U.S. Cl. 716/3

(57) ABSTRACT

A mapping device is provided that can map a combinational circuit to a selector base cell at high speed, with a small memory capacity. A selector base circuit creator creates a selector base circuit from a combinational circuit to be mapped. The controller manages the selector base circuit created by the selector base circuit creator and stores it into the selector base circuit memory. The selector base modifier retrieves selectors, which can be synthesized together within the selector base circuit, from the selector base circuit memory and combines the selectors based on the retrieval result, thus performing logic consolidation. The mapping cellulating unit maps a selector base cell after selector synthesis, to a selector base circuit of one type that can express arbitrary three-input logic.

### BACKGROUND OF THE INVENTION

The present invention relates to a mapping device, a mapping method, and a program therefor, each for mapping a circuit composed of selector base cells peculiar to a technology. Particularly, the present invention relates to a mapping device, a mapping method, and a program therefor, each for transforming a combinational circuit into a selector base circuit and then mapping the transformed selector base circuit configured into a selector base cell. There are some mapping methods for mapping devices. For example, all gates in a circuit are converted into a NAND gate (or a circuit in which gate logic is constituted of plural NAND gates connected together). Cells inherent to a technology used in mapping are converted into a NAND gate. Then, the connection status among NAND gates converted from gates in the circuit is compared with the connection status among NAND gates converted from the cells inherent to the technology. Thus, based on the comparison results, the NAND gates of the same type in the circuit are substituted for cells inherent to the technology. This technology is described in the paper, K. Keutzer, “DAGON: Technology binding and logical optimization by DAG matching”, ACM/IEEE Design Automation Conference 1987.

Moreover, the following method is another mapping method for mapping devices.

This method comprises the steps of retrieving all partial circuits with four inputs (or 4 or less inputs) and with one output in a circuit and substituting the retrieved partial circuits for cells of a memory base called a look-up table. This technology is described in the paper, “FlowMap: An Optimal Technology Mapping Algorithm for Delay Optimization in Lookup-Table Based FPGA Designs”, IEEE Transactions on Computer-Aided Design 1994.

However, the mapping method for the former mapping device has the drawback in that increasing the number of cells results in taking much time in the comparison process.

The mapping method of the latter mapping device has the drawback in that the mapping result largely depends on the gate connection status of a circuit to be mapped.

### SUMMARY OF THE INVENTION

The present invention is made to solve the above-mentioned problems. An object of the present invention is to provide a technology of capable of reducing the number of created selector base cells and performing a high-speed mapping process, without depending on the status of gate connection of a circuit to be mapped.

In order to accomplish the object, a mapping device with logic consolidation function, wherein a combinational circuit is logically transformed into a selector base circuit, comprises a transformer for extracting a gate except a selector from a combinational circuit and converting the extracted gate into a selector, thus transforming the combinational circuit into a selector base circuit; a memory for storing the selector base circuit transformed; a logic consolidator for implementing logic consolidation by reading out a selector base circuit from the memory, by retrieving selectors which can be synthesized within the selector base circuit read out, and by synthesizing the retrieved selectors; means for substituting the retrieved selector within a selector base circuit stored in the memory for the logically-consolidated selector; and a mapper for reading out a selector base circuit after substitution stored in the memory and mapping the read-out selector base circuit to the selector base cell.

In another aspect of the present invention, a mapping device with logic consolidation function, wherein a combinational circuit is logically synthesized into a selector base circuit, comprises a transformer for extracting a gate except a selector from a combinational circuit and converting the extracted gate into a selector, thus transforming the combinational circuit into a selector base circuit; a logic consolidator for implementing logic consolidation by retrieving selectors which can be synthesized within the selector base circuit and by synthesizing the retrieved selectors; and a mapper for mapping the logically-consolidated selector base circuit to a selector base cell.

In the mapping device according to the present invention, the logic consolidator comprises means for deciding, when a selector is synthesized by selectors within a selector base circuit, whether or not a select line of a selector connected to a select line of a predetermined selector is the same as a select line of a selector connected to a data line of the predetermined selector, and synthesizing, when the two select lines are the same, the predetermined selector with a selector connected to an input side of the selector.

In the mapping device according to the present invention, the selector base cell comprises a selector base cell of a type by which arbitrary three-input logic is expressible. In another aspect of the present invention, a mapping method with logic consolidation function, wherein a combinational circuit is logically transformed into a selector base circuit, comprises steps of selecting a gate, except a selector, from a combinational circuit and converting the selected gate into a selector, thus converting the combinational circuit into a selector base circuit; storing the selector base circuit transformed; implementing logic consolidation by retrieving selectors which can be synthesized within the selector base circuit stored and by synthesizing the retrieved selectors; substituting the retrieved selector within a selector base circuit stored in the memory for the logically-consolidated selector; and mapping the selector base circuit after substitution stored to the selector base cell.

In another aspect of the present invention, a mapping method with logical reduction function, wherein a combinational circuit is logically synthesized into a selector base circuit, comprises the steps of selecting a gate, except a selector, from a combinational circuit and converting the extracted gate into a selector, thus transforming a combinational circuit into a selector base circuit; implementing logic consolidation by retrieving selectors which can be synthesized within the selector base circuit and by synthesizing the retrieved selectors; and mapping the logically-consolidated selector base circuit to a selector base cell.

In the method according to the present invention, the selector base cell comprises a selector base cell of a type by which arbitrary three-input logic is expressible.

In the method according to the present invention, the logic consolidating step comprises the step of deciding, when a selector is synthesized by selectors within a selector base circuit, whether or not a select line of a selector connected to a select line of a predetermined selector is the same as a select line of a selector connected to a data line of the predetermined selector, and synthesizing, when the two select lines are the same, the predetermined selector with a selector connected to an input side of the selector.

Another aspect of the present invention is characterized by a program for executing, to an information processor that constitutes a mapping device with logic consolidation function, the mapping device logically transforming a combinational circuit into a selector base circuit, the steps of selecting a gate, except a selector, from a combinational circuit and converting the selected gate into a selector, thus transforming the combinational circuit into a selector base circuit; storing the selector base circuit transformed; implementing logic consolidation by retrieving selectors which can be synthesized within the selector base circuit stored and by synthesizing the retrieved selectors; substituting the retrieved selector with a selector base circuit stored in the memory for the logically-consolidated selector; and mapping the stored selector base circuit to the selector base cell.

Another aspect of the present invention is characterized by a program for executing, to an information processor that constitutes a mapping device with logic consolidation function, the mapping device logically transforming a combinational circuit into a selector base circuit, the steps of selecting a gate, except a selector, from a combinational circuit and converting the selected gate into a selector, thus transforming a combinational circuit into a selector base circuit; implementing logic consolidation by retrieving selectors which can be synthesized within the selector base circuit and by synthesizing the retrieved selectors; and mapping said logically-consolidated selector base circuit to a selector base cell.

In the program according to the present invention, the selector base cell comprises a selector base cell of a type by which arbitrary three-input logic is expressible.

In the program according to the present invention, the logic consolidating step comprises the step of deciding, when a selector is synthesized by selectors within a selector base circuit, whether or not a select line of a selector connected to a select line of a predetermined selector is the same as a select line of a selector connected to a data line of the predetermined selector, and synthesizing, when the two select lines are the same, the predetermined selector with a selector connected to an input side of the selector.

Another aspect of the present invention is characterized by a recording medium wherein a program is stored. The program executes, to an information processor that constitutes a mapping device with logic consolidation function, the mapping device logically transforming a combinational circuit into a selector base circuit, the steps of selecting a gate, except a selector, from a combinational circuit and converting the selected gate into a selector, thus transforming the combinational circuit into a selector base circuit; storing the selector base circuit transformed; implementing logic consolidation by retrieving selectors which can be synthesized within the selector base circuit stored and by synthesizing the retrieved selectors; substituting the retrieved selector with a selector base circuit stored in the memory for the logically-consolidated selector; and mapping the stored selector base circuit to the selector base cell.

Another aspect of the present invention, the present invention is characterized by a recording medium wherein a program is stored.

The program executes, to an information processor that constitutes a mapping device with logic consolidation function, the mapping device logically transforming a combinational circuit into a selector base circuit, the steps of selecting a gate, except a selector, from a combinational circuit and converting the selected gate into a selector, thus transforming a combinational circuit into a selector base circuit; implementing logic consolidation by retrieving selectors which can be synthesized within the selector base circuit and by synthesizing the retrieved selectors; and mapping the logically-consolidated selector base circuit to a selector base cell.

### BRIEF DESCRIPTION OF THE DRAWINGS

This and other objects, features and advantages of the present invention will become more apparent from the following detailed description taken in conjunction with the attached drawings, in which:

FIG. 1 is a diagram explaining a method for transforming an AND gate into a selector;

FIG. 2 is a diagram explaining a method for transforming an OR gate into a selector;

FIG. 3 is a diagram explaining a method for transforming an NAND gate into a selector;

FIG. 4 is a diagram explaining a method for transforming an NOR gate into a selector;

FIG. 5 is a diagram explaining a method for transforming an EXOR gate into a selector;

FIG. 6 is a diagram explaining selector synthesis of a selector;

FIG. 7 is a diagram explaining an embodiment;

FIG. 8 is a diagram explaining an embodiment;

FIG. 9 is a diagram explaining an embodiment;

FIG. 10 is a diagram explaining an embodiment;

FIG. 11 is a block diagram illustrating a mapping device;

FIG. 12 is a diagram explaining the circuit memory 502;

FIG. 13 is a diagram explaining the selector base circuit memory 504;

FIG. 14 is a flowchart explaining the operation of an embodiment;

FIG. 15 is a diagram explaining the operation of an embodiment;

FIG. 16 is a diagram explaining the operation of an embodiment;

FIG. 17 is a diagram explaining the operation of an embodiment;

FIG. 18 is a diagram explaining the operation of an embodiment;

FIG. 19 is a block diagram illustrating a mapping device;

FIG. 20 is a schematic diagram illustrating a structural device wherein a selector base circuit mapping device is realized with a computer; and

FIG. 21 is a flowchart explaining the operation of an embodiment.

### DESCRIPTION OF THE EMBODIMENTS

A first embodiment of the present invention will be described below.

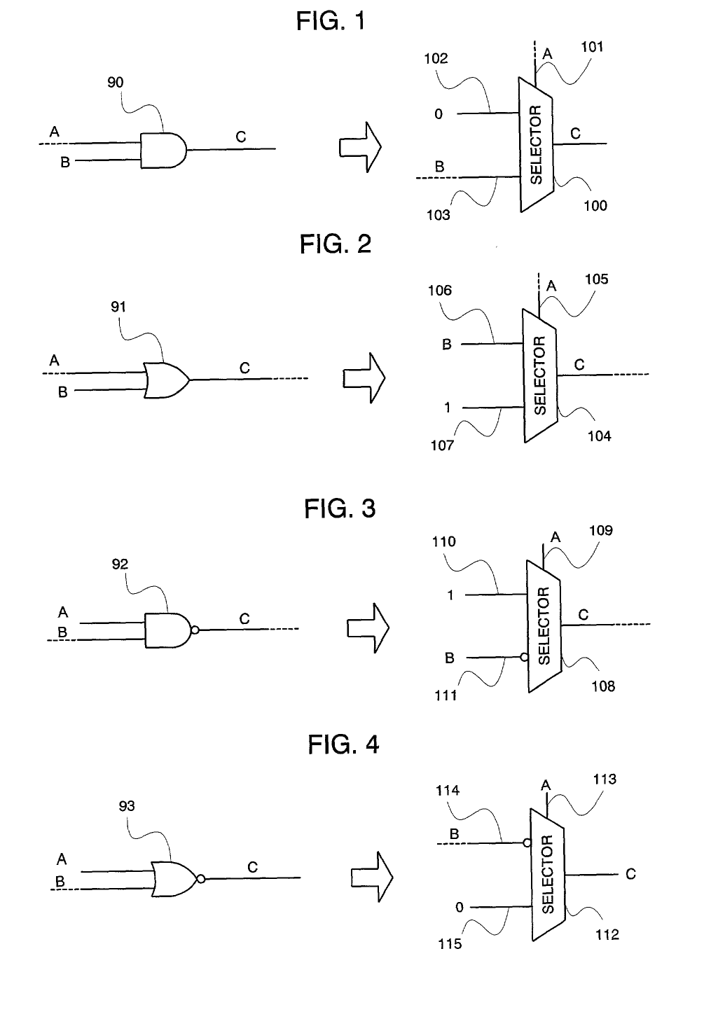

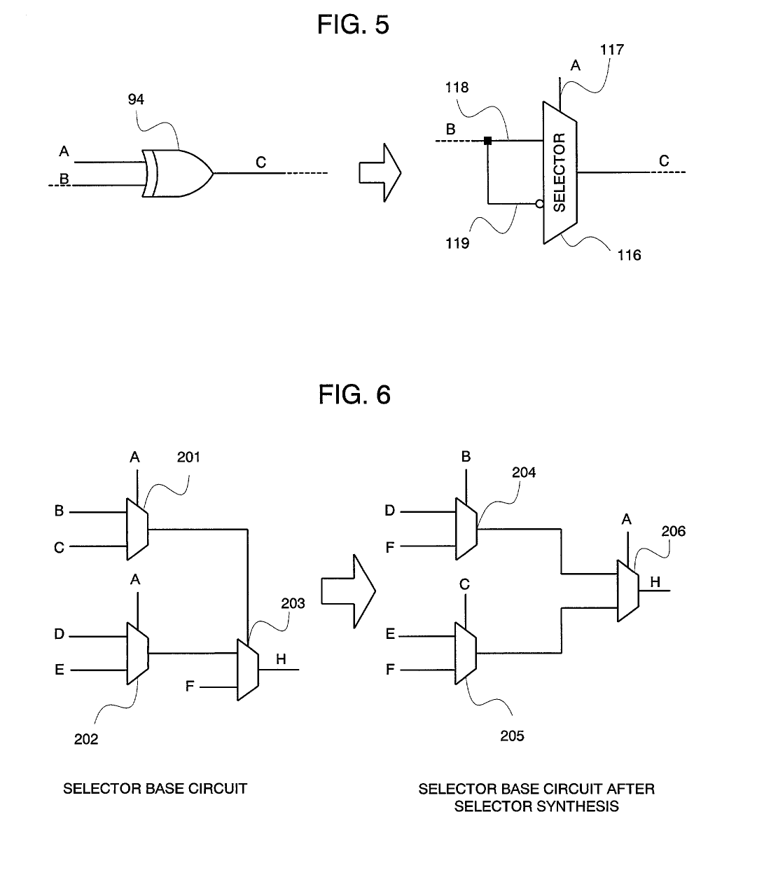

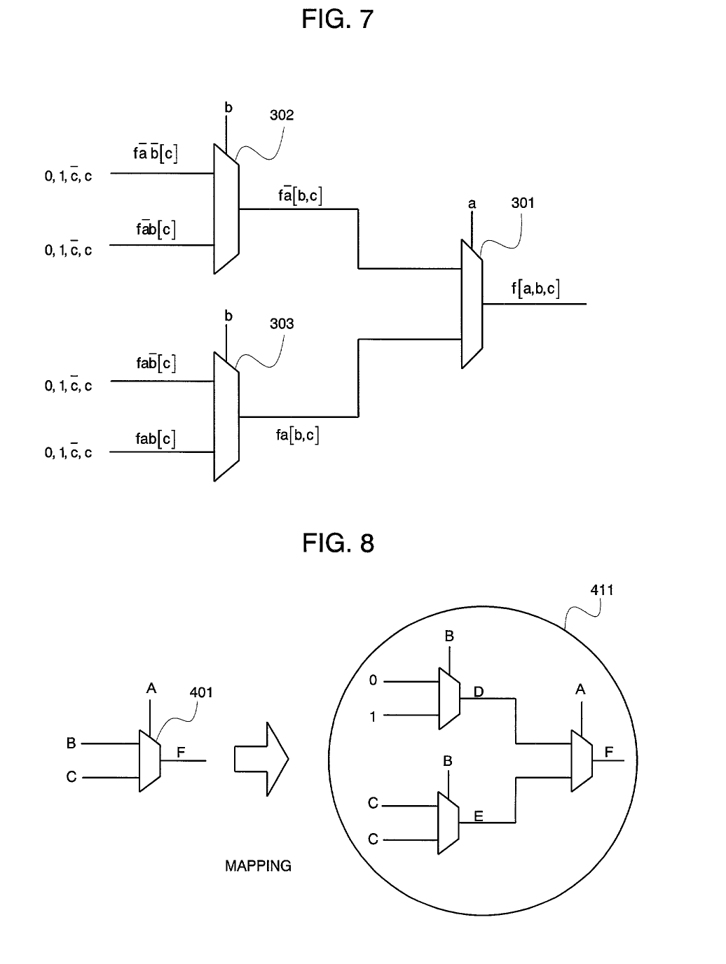

FIG. 1 is a diagram explaining a method of transforming an AND gate into a selector. FIG. 2 is a diagram explaining a method of transforming an OR gate into a selector. FIG. 3 is a diagram explaining a method of transforming a NAND gate into a selector. FIG. 4 is a diagram explaining a method of transforming a NOR gate into a selector. FIG. 5 is a diagram explaining a method of transforming an EXOR gate into a selector. FIG. 6 is a diagram explaining selector synthesis. FIGS. 7 to 10 are diagrams each explaining an embodiment.

A combinational circuit is a circuit formed of logic gates including an inverter, an AND gate, an OR gate, a NAND gate, a NOR gate, an EXOR gate, and a selector. Each of AND, OR, NAND, NOR, and EXOR has two inputs. The selector is a 2-to-1 selector having two data input lines, one select line, and one data output line.

A mapping device stores data about a combinational circuit to be mapped (hereinafter the data about a combinational circuit may be merely referred to as a combinational circuit). All logic gates, such as AND logic or OR logic, being a gate logical factor, among the gate logical factors and the wiring factors of the stored combinational circuit are transformed into selector logic. The method of transforming respective gates into a selector will be explained below by referring to FIGS. 1 to 5.

(A) AND gate to selector transformation will be explained.

Referring to FIG. 1, it is assumed that

(a)when a signal of 0 is input to the select line 101, the selector 100 selects the data line 102 and that

(b) when a signal of 1 is input to the select line 101, the selector 100 selects the data line 103. In order to transform the AND gate 90 into a selector,

(1)the selector 100 is created.

(2)One input (e.g. the input signal line A) of the AND gate 90 in FIG. 1 is selected and the selected signal line A is connected to the select line 101 of the selector 100.

(3)When a signal of 0 is input to the selected signal line A, the output logic of the AND gate 90 is obtained (in FIG. 1, the output logic of the AND gate 90 is 0). The data line in the output logic is connected to the data line 102 to be selected when a signal of 0 is input to the select line 101 of the selector 100.

(4) When a signal of 1 is input to the selected signal line A, the output logic of the AND gate 90 (e.g. the output logic B of the AND gate 90 in FIG. 1) is obtained. Then, the data line in the output logic is connected to the data line 103 to be selected when a signal of 1 is input to the select line 101 of the selector 100.

In this case, by respectively substituting X and Y and for 0 and B in the selector logical equation,

C=X*\overline{A}+Y*A, C=0*\overline{A}+B*A=B*A

Hence, this equation is expressed as AND of A and B. This proves the correctness of the conversion method. X represents the signal line selected when a signal of 0 is input to the select line A. Y represents the signal line selected when a signal of 1 is input to the select line A.

(B) OR gate to selector transformation will be explained.

In FIG. 2, the selector 104 is similar to the selector 100. The OR gate 91 is transformed into the selector 104 as follows:

(1) the selector 104 is created.

(2) One input (e.g. the input signal line A) of the OR gate 91 in FIG. 2 is selected and connected to the select line 105 of the selector 104.

(3) When a signal of 0 is input to the selected signal line A, the output logic (e.g. B) of the OR gate 90 in FIG. 2 is obtained. The data line in the output logic is connected to the data line 106 to be selected when a signal of 0 is input to the select line 105 of the selector 104.

(1) When a signal of 1 is input to the signal line A, the output logic (e.g. 1) of the OR gate 91 in FIG. 2 is obtained. Then, the data line in the output logic is connected to the data line 107 to be selected when a signal of 1 is input to the select line 105 of the selector 104.

(C) NAND gate to selector transformation will be explained.

In FIG. 3, the selector 108 is similar to the selector 100 in FIG. 1. The NAND gate 92 is transformed as follows:

(1) the selector 108 is created.

(2) One input (e.g. the input signal line A) of the NAND gate 92 in FIG. 3 is selected and connected to the select line 109 of the selector 108.

(3) When a signal of 0 is input to the selected signal line A, the output logic (e.g. 1) of the NAND gate 92 in FIG. 3 is obtained. The data line in the output logic is connected to the data line 110 to be selected when a signal of 0 is input to the select line 109 of the selector 108.

(4) When a signal of 1 is input to the selected signal line A, the output logic (e.g. NOTB) of the NAND gate 92 in FIG. 3 is obtained. Then, the data line in the output logic is connected to the data line 111 to be selected when a signal of 1 is input to the select line 109 of the selector 108.

(D) NOR gate to selector transformation will be explained.

In FIG. 4, the selector 112 is similar to the selector 100 in FIG. 1. The NOR gate 93 is transformed into the selector 112, as follows:

(1) the selector 112 is created.

(2) One input (e.g. the select line A) of the NOR gate 93 in FIG. 4 is selected and connected to the select line 113 of the selector 112.

(3) When a signal of 0 is input to the selected signal line A, the output logic (e.g. NOTB) of the NOR gate 93 in FIG. 4 is obtained. The data line in the output logic is connected to the data line 114 to be selected when a signal of 0 is input to the select line 113 of the selector 112.

(4) When a signal of 1 is input to the signal A, the output logic (e.g. 0) of the NOR gate 93 in FIG. 4 is obtained. Then, the data line in the output logic is connected to the data line 115 to be selected when a signal of 1 is input to the select line 113 of the selector 112.

(E) EXOR gate to selector transformation will be explained.

In FIG. 5, the selector 116 is similar to the selector 100 shown in FIG. 1. The NOR gate 94 is transformed into the selector 116, as follows:

(1) The selector 116 is created.

(2) One input (e.g. the input signal line A) of the NOR gate 94 in FIG. 5 is selected and connected to the select line 117 of the selector 116.

(3) When a signal of 0 is input to the signal line A, the output logic (e.g. B) of the EXOR gate 94 in FIG. 5 is obtained. Then, the data line in the output logic is connected to the data line 118 to be selected when a signal of 0 is input to the select line 117 of the selector 116.

(4) When a signal of 1 is input to the signal A, the output logic (e.g. NOTB) of the EXOR gate 94 in FIG. 5 is obtained. Then, the data line in the output logic is connected to the data line 119 to be selected when a signal of 1 is input to the select line 117 of the selector 116.

The data on the selector base circuit subjected to the selector logic transformation (or the data may be merely referred to as a selector base circuit) is stored. Then, among selectors within the logically-transformed selector base circuit, it is judged whether or not the select line of a selector connected to the select line of a selector is identical to the select line of a selector connected to the data signal line of the same selector.

When the two select lines are the same, selectors with the same select line are combined together to implement logic consolidation.

As shown in FIG. 6, it is now assumed that

(1) when a signal of 0 is input to the select lines A of the selector 201 and 202, the data line B of the selector 201 is connected to the select line of the selector 203 while the data lines D and F of the selector 202 are connected to the data line of the selector 203 and that

(2) when a signal of 1 is input to the select lines of the selector 201 and 202, the data line C of the selector 201 is connected to the select line of the selector 203 while the data lines E and F of the selector 202 are connected to the data line of the selector 203.

First, the selector 204 that operates in a manner similar to that when a signal 0 is input to the select line A is created. Next, the selector 205 that operates in a manner similar to that when a signal 1 is input to the select line A. Moreover, the selector 206 that determines a selector to be selected when a signal of 0 or 1 is input to the select line A is created.

A selector before logic consolidation of a stored selector base circuit is substituted for a selector after logic consolidation.

Next, the logically-consolidated selector base circuit is mapped to a selector base cell of a type by which arbitrary three input logic is expressible.

The configuration of the selector base cell will be specifically explained below.

Referring to FIG. 7, the selector 301 transforms an arbitrary function f(a, b, c) into the following equation, using an arbitrary variable a.

f(a,b,c)=\overline{a}*f_{\overline{a}}(bc)+a*fₐ(b,c)

where f(a,b,c) is an arbitrary logic having as inputs three variables a, b and c;

f_{\overline{a}}(b,c), fₐ(b, c)

are arbitrary logical function having two variables b and c.

Moreover, using the variable b, the selector 302 transforms

f_{\overline{a}}(b,c)

into

f_{\overline{a}}(b,c)=\overline{b}*f_{\overline{ab}}(c)+b*f_{\overline{ab}}(c) (a)

Using the variable b, the selector 303 transforms

fₐ(b,c)

into

fₐ(b,c)=\overline{b}*f_{\overline{ab}}(c)+b*f_{ab}(c) (b)

In the equations (a) and (b), each of

f_{\overline{ab}}(c), f_{\overline{ab}}(c), f_{\overline{ab}}(c), f_{ab}(c)

is an arbitrary function having one variable c as an input and has any one of 0, 1, c, and c.

Next, the mapping method using selector base cells will be explained below.

In any one of the following three cases (1), (2) and (3), it is judged whether or not the mapping is possible from the input side of the selector base circuit every selector s (hereinafter, the judgement is called covering).

(1) A selector base cell can be realized by the selector s alone.

(2) A selector base cell can be realized of two selectors, including the selector s and the second selector x on the input side of any one of data lines of the first selector s (in this case, the signal to be input to the data line (not connected to the selector x) of the selector s is a constant).

(3) A selector base cell can be realized of three selector base cells, including the selector s and the selectors x and y on the input sides of two data lines of the selector s (in this case, the select line of the selector x is identical to the select line of the selector y). In this invention, covering is performed to bring a large number of selectors to one selector base cell.

When a selector base cell can be realized in the case (3), the selector base cell is realized.

When a selector base cell cannot be realized in the case (3) but can be realized in the case (2), the selector base cell is realized.

When a selector base cell cannot be realized in the cases (2) and (3) but can be realized in the case (1), a selector base cell can be realized.

For example, the case of the case (1) is shown in FIG. 8. With the selector 401 corresponding to the selector s, the selector group 411 is obtained by covering the selector 401. In this case, D is expressed by the following equation.

D=0*\overline{B}+1*B=B

E is expressed by the following equation.

E=C*\overline{B}+C*B=C*(\overline{B}+B)=C

Hence, it is understand that the mapping of the selector base cell is logically correct.

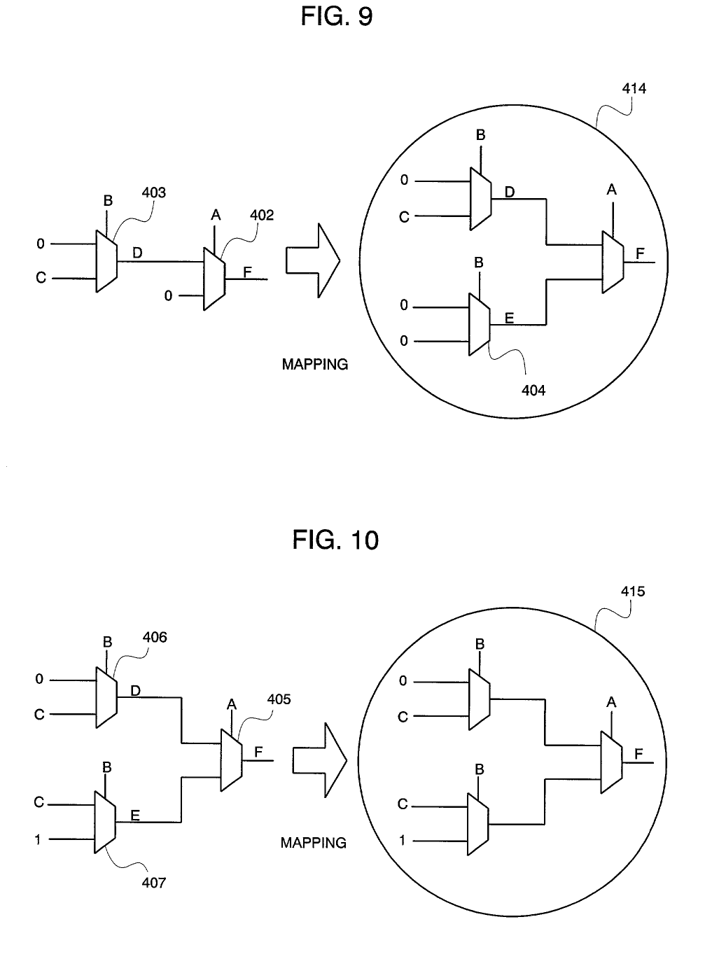

The case (2) is shown in FIG. 9. With the selector 402 corresponding to the selector s and the selector 403 corresponding to the selector x, the selectors 402 and 403 are subjected to covering so that the selector group 414 is realized. Since the constant 0 is input to the data line of the selector 402, the selector 402 can be realized with the selector 404.

The case (3) is shown in FIG. 10. With the selector 405 corresponding to the selector s, the selector 406 correcting to the selector x, and the selector 407 corresponding to the selector y, three selectors 405, 406, and 407 are subjected to covering so that the selector group 415 is obtained.

Moreover, after covering is performed every selector from the input side of the selector base circuit, optimum covering is selected from the output side of the selector base circuit. A selector cell is created every the selected covering. That is, the following process is performed from the output side of the selector base circuit.

(1) Of the foregoing coverings, the covering including the selector having as a self output signal line the output signal line of a selector base circuit is selected.

(2) A selector base cell is created every selected covering. It is judged whether or not the covering exists including the input side connected to the input side of the selected covering (however when the input side of the covering corresponds to the input of the selector base circuit, the covering is not selected as an object).

(3) When the covering to be selected exists, the process returns to the case (2). When the covering to be selected does not exist, the process is ended.

The selector base cell thus created is output as a mapping result.

Next, the mapping apparatus realizing the above-mentioned method will be explained below.

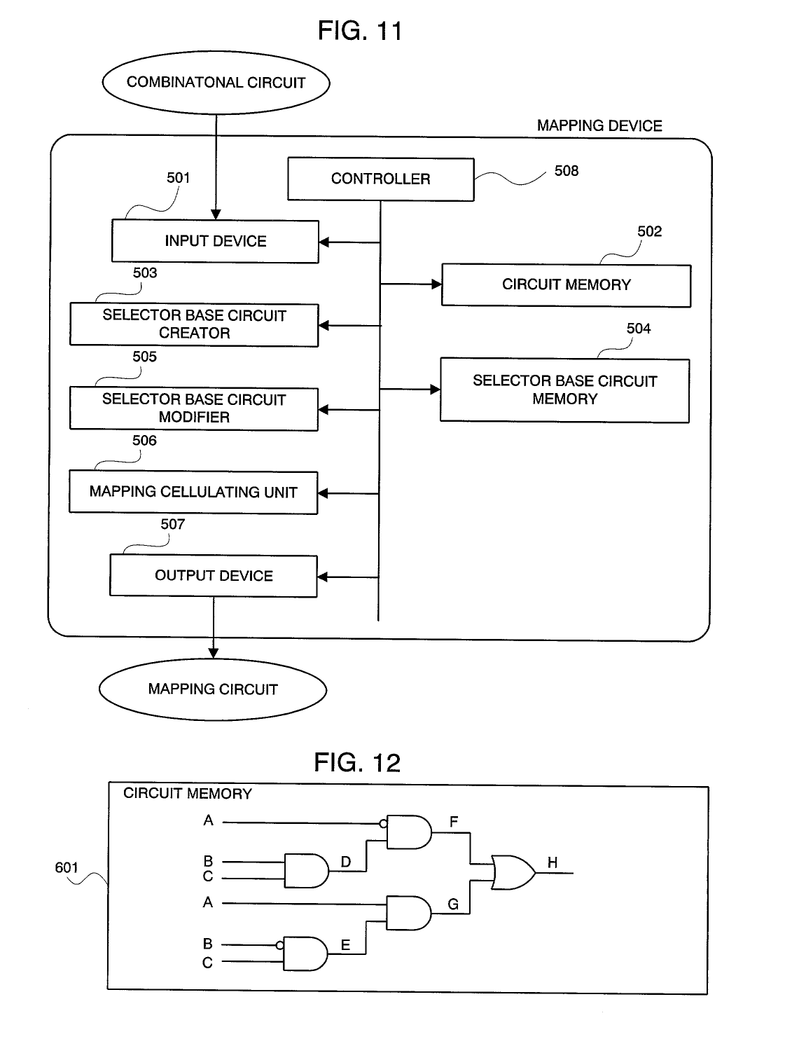

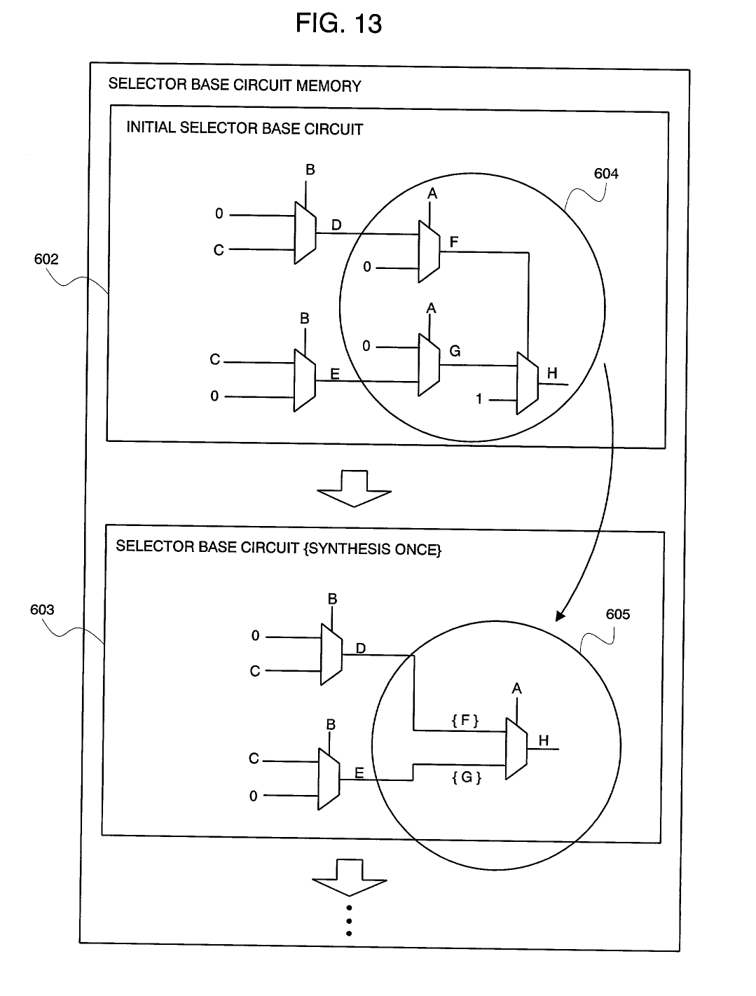

FIG. 11 is a block diagram illustrating a mapping device. FIG. 12 is a diagram illustrating explaining the circuit memory 502. FIG. 13 is a diagram explaining the base circuit memory 504.

As shown in FIG. 11, a mapping device with logic consolidation function includes an input device 501, a circuit memory 502, a selector base circuit creator 503, a selector base circuit memory 504, a selector base circuit modifier 505, a mapping cellulating unit 506, an output device 507, and a controller 508.

The input device 501 receives a combinational circuit to be mapped. The combinational circuit means a circuit configured of logic gates such as an inverter, AND, OR, NAND, NOR, EXOR, and a selector.

In this embodiment, each of AND, OR, NAND, NOR, and EXOR has two inputs. The selector is a 2 to 1 selector (having two data input lines, one select line, and one data output line).

The circuit memory 502, as shown in FIG. 12, stores a combinational circuit from the input device 501.

The selector base circuit creator 503 transforms into a selector base circuit all gate logic such as AND logic, OR logic, and the like, being gate logical factors, of gate logical factors and wiring factors of a combinational circuit read out from the circuit memory 502.

Transformation from gate logic to selector logic will be explained below referring to FIGS. 1 to 5.

(A) AND gate to selector transformation method will be explained.

For example, it is assumed that the selector 100, as shown in FIG. 1, operates as follows:

(a) When a signal of 0 is input to the select line 101, the selector 100 selects the data line 102.

(b) When a signal of 1 is input to the select line 101, the selector 100 selects the data line 103. In such conditions, the select base circuit creator 503 operates as follows:

(1) creates the selector 100;

(2) selects one of inputs (the input signal line A) of the AND gate 90 in FIG. 1 and connects the selected signal line A to the select line 101 of the selector 100;

(3) when a signal of 0 is input to the signal line A selected in the case (2), the selector base circuit creator 503 obtains the output logic (e.g. 0) of the AND gate 90 in FIG. 1 and connects the data line in the output logic to the data line 102 to be selected when a signal of 0 is input to the select line 101 of the selector 100; and

(4) when a signal of 1 is input to the signal line A selected in the case (2), the selector base circuit creator 503 obtains the output logic (e.g. B) of the AND gate 90 in FIG. 1 and connects the data line in the output logic to the data line 102 to be selected when a signal of 1 is input to the select line 101 of the selector 100.

(B) OR gate to selector transformation method will be explained.

For example, the selector 104 shown in FIG. 2 is similar to the selector 100 in FIG. 1. The select base circuit creator 503 operates as follows:

(1) creates the selector 104;

(2) selects an input (the input signal line A) of the OR gate 91 in FIG. 2 and connects the selected signal line A to the select line 105 of the selector 104;

(3) when a signal of 0 is input to the signal line A selected in the case (2), the selector base circuit creator 503 obtains the output logic (e.g. B) of the OR gate 91 in FIG. 1 and connects the data line in the output logic to the data line 106 to be selected when a signal of 0 is input to the select line 105 of the selector 104; and

(4) when a signal of 1 is input to the signal line A selected in the case (2), the selector base circuit creator 503 obtains the output logic (e.g. 1) of the OR gate 91 in FIG. 1 and connects the data line in the output logic to the data line 107 to be selected when a signal of 1 is input to the select line 105 of the selector 104.

(C) NAND gate to selector transformation method will be explained.

For example, the selector 108 shown in FIG. 3 is similar to the selector 100 in FIG. 1. The select base circuit creator 503 operates as follows:

(1) creates the selector 108;

(2) selects an input (e.g. A) of the NAND gate 92 in FIG. 3 and connects the selected signal line A to the select line 109 of the selector 108;

(3) when a signal of 0 is input to the signal line A selected in the case (2), the selector base circuit creator 503 obtains the output logic (e.g. 1) of the NAND gate 92 in FIG. 3 and connects the data line in the output logic to the data line 110 to be selected when a signal of 0 is input to the select line 109 of the selector 108; and

(4) when a signal of 1 is input to the signal line A selected in the case (2), the selector base circuit creator 503 obtains the output logic (e.g. NOTB) of the NAND gate 92 in FIG. 3 and connects the data line in the output logic to the data line 110 to be selected when a signal of 1 is input to the select line 109 of the selector 108.

(D) NOR gate to selector transformation will be explained.

For example, the selector 108 shown in FIG. 4 is similar to the selector 100 in FIG. 1. The select base circuit creator 503 operates as follows:

(1) creates the selector 112;

(2) selects an input (e.g. A) of the NOR gate 93 in FIG. 4 and connects the selected signal line A to the select line 113 of the selector 112;

(3) when a signal of 0 is input to the signal line A selected in the case (2), the selector base circuit creator 503 obtains the output logic (e.g. NOTB) of the NOR gate 93 in FIG. 4 and connects the data line in the output logic to the data line 114 to be selected when a signal of 0 is input to the select line 113 of the selector 112; and

(4) when a signal of 1 is input to the signal line A selected in the case (2), the selector base circuit creator 503 obtains the output logic (e.g. 0) of the NOR gate 93 in FIG. 4 and connects the data line in the output logic to the data line 115 to be selected when a signal of 1 is input to the select line 113 of the selector 112.

(E) EXOR gate to selector transformation will be explained.

For example, the selector 116 shown in FIG. 5 is similar to the selector 100 in FIG. 1. The select base circuit creator 503 operates as follows:

(1) creates the selector 116;

(2) selects an input (the input signal line A) of the NOR gate 94 in FIG. 5 and connects the selected signal line A to the select line 117 of the selector 116;

(3) when a signal of 0 is input to the signal line A selected in the case (2), the selector base circuit creator 503 obtains the output logic (e.g. the output logic B) of the EXOR gate 94 in FIG. 5 and connects the data line in the output logic to the data line 118 selected when a signal of 0 is input to the select line 117 of the selector 116; and

(4) when a signal of 1 is input to the signal line A selected in the case (2), the selector base circuit creator 503 obtains the output logic (e.g. the output logic NOTB) of the EXOR gate 94 in FIG. 5 and connects the data line in the output logic to the data line 119 selected when a signal of 1 is input to the select line 117 of the selector 116.

The selector base circuit memory 504 stores the selector base circuit created by the selector base circuit creator 503 and the selector base circuit logically consolidated by the selector base circuit modifier 505.

Among selectors within a selector base circuit read out from the selector base circuit memory 504, the selector base circuit modifier 505 judges whether or not the select line of a selector connected to the select line of a selector is identical to the select line of a selector connected to the data signal line of the same selector. When the two select lines are the same, the selector base circuit modifier 505 synthesizes selectors having the same select lines to implement logic consolidation.

For example, the selector base circuit modifier 505 operates as shown in FIG. 6.

(1) When a signal of 0 is input to the select lines A of the selectors 201 and 202, the data line B of the selector 201 is connected to the select line of the selector 203 while the data line D of the selector 202 and the data line F are connected to the data line of the selector 203.

(2) When a signal of 1 is input to the select lines A of the selectors 201 and 202, the data line C of the selector 201 is connected to the select line of the selector 203 while the data lines E of the selector 202 and the data line F are connected to the data line of the selector 204.

In such conditions, the selector 204 is first created that operates in a manner similar to the operation when a signal of 0 is input to the selector A. Next, the selector 205 is created that operates in a manner similar to the operation when a signal of 1 is input to the selector A. Moreover, when a signal of 0 or 1 is input to the select line A, the selector 206 is created that determines a selector to be selected.

The mapping cellulating unit 506 reads out from the selector base circuit after logic consolidation from the selector base memory 504 and then maps the read-out selector base circuit to a selector base cell of one type by which arbitrary three input logic is expressible.

This operation will be explained below in detail.

The configuration of a selector base cell will be explained below.

For example, the selector 301 transforms the arbitrary function f(a, b, c) into the following equation, using the variable a, as shown in FIG. 1.

f(a,b,c)=\overline{a}*f_{\overline{a}}(b,c)+a*fₐ(b,c)

where f(a,b,c) is an arbitrary logic to which three variables a, b, and c are input;

f_{\overline{a}}(c), fₐ(b,c)

are arbitrary logical function having two variables b and c as an input.

Moreover, the selector 302 transforms

f_{\overline{a}}(b,c)

into

f_{\overline{a}}(b,c)=\overline{b}*f_{\overline{ab}}(c)+b*f_{\overline{ab}}(c) (a)

using the variable b.

The selector 303 transforms

fₐ(b,c)

into

fₐ(b,c)=\overline{b}*f_{\overline{ab}}(c)+b*f_{ab}(c) (b)

using the variable b.

Where each

f_{\overline{ab}}(c), f_{\overline{ab}}(c), f_{\overline{ab}}(c), f_{ab}(c)

is an arbitrary logical function having one variable c as an input. Each arbitrary function has any one of 0, 1, c, and c.

Next, the operation of mapping a selector base circuit to a selector base cell will be explained below. The mapping cellulating unit 506 judges whether or not a selector base cell can be created every selector s from the input side of the selector base circuit, in the following cases.

(1) The selector base cell can be realized by the selector s alone.

(2) A selector base cell can be realized by two selectors, including the selector s and the selector x on the input side of any one of data lines of the selector s (in this case, the signal to be input to the data line (not connected to the selector x) of the selector s must be a constant).

(3) A selector base cell can be created by three selector base cells, including the selector s and the selectors x and y on the input sides of two data lines of the selector s. (in this case, the select line of the selector x must be identical to the select line of the selector y).

In any case, it is judged whether or not a selector base can be created (hereinafter this judgment is called covering).

The selector base circuit modifier 505 creates a selector base cell in the following cases.

That is, when a selector base cell can be created in the case (3), the selector base circuit modifier 505 creates a selector base cell.

When a selector base cell cannot be created in the case (3) but can be created in the case (2), the selector base circuit modifier 505 creates a selector base cell.

When a selector base cell cannot be created in the cases (2) and (3) but can be created in the case (1), the selector base circuit modifier 505 creates a selector base cell.

For example, FIG. 8 shows the case (1). If the selector 401 corresponds to the selector s, the selector group 411 is obtained by covering the selector 401.

FIG. 9 shows the case (2). If the selector 402 corresponds to the selector s and the selector 403 corresponds to the selector x, the selector group 414 is obtained by covering the selectors 402 and 403. In this case, since a constant of 0 is input to the data line of the selector 402, the selector 402 can be expressed with selector 404.

FIG. 10 shows the case (3). If the selector 405 corresponds to the selector s and the selector 406 corresponds to the selector x and the selector 407 corresponds to the selector y, the selector group 415 is obtained by covering three resistors 405, 406 and 407.

After the covering is performed to each selector from the input side of the selector base circuit, optical covering is selected from the output side of the selector base circuit. A selector base cell is created every selected covering. That is, the following operations are performed from the output side of the selector base circuit.

(1) Of the coverings, the covering including a selector having as a self output signal line the output signal line of a selector base circuit is selected.

(2) A selector base cell is created every selected covering. It is judged whether or not the covering including the selector connected to the input side of the selected covering exists (However, the covering of which the input side is the input of the selector base circuit is not selected as the covering to be selected).

(3) When the covering to be selected exists, the operation of the case (2) is further performed. When the covering to be selected does not exist, the process is ended.

The output device 507 outputs the result obtained by mapping a selector base circuit to a selector base cell by means of the mapping cellulating unit 506.

After storing a combinational circuit from the input device 501 into the circuit memory 502, the controller 508 controls the selector base circuit creator 503 to convert a gate within the stored combinational circuit into a selector, thus creating a selector base circuit from the combinational circuit. Thus, the selector base circuit memory 504 stores the selector base circuit created by the selector base circuit creator 503. The selector base circuit modifier 505 retrieves selectors which can be synthesized within the selector base circuit stored in the selector base circuit memory 504. Thus, the retrieved selectors are synthesized so that the logic consolidation is implemented. Moreover, the selector before the logic consolidation of the selector base circuit stored in the selector base circuit memory 504 is substituted for the selector after the logic consolidation. For example, the selector base circuit before logic consolidation stored in the selector base circuit memory 504 is the selector base circuit 602 for logic consolidation, as shown in FIG. 13. In such a case, the controller 508 substitutes the selector group 604 before logic consolidation of the selector base circuit stored in the selector base circuit memory 504 for the selector 605 before logic consolidation. Thereafter, the mapping cellulaing unit 506 maps the selector base circuit after logic consolidation stored in the selector base circuit memory 504 to the selector base cell. Then, the output device 507 outputs the mapping result.

The operation of the mapping device will be explained below.

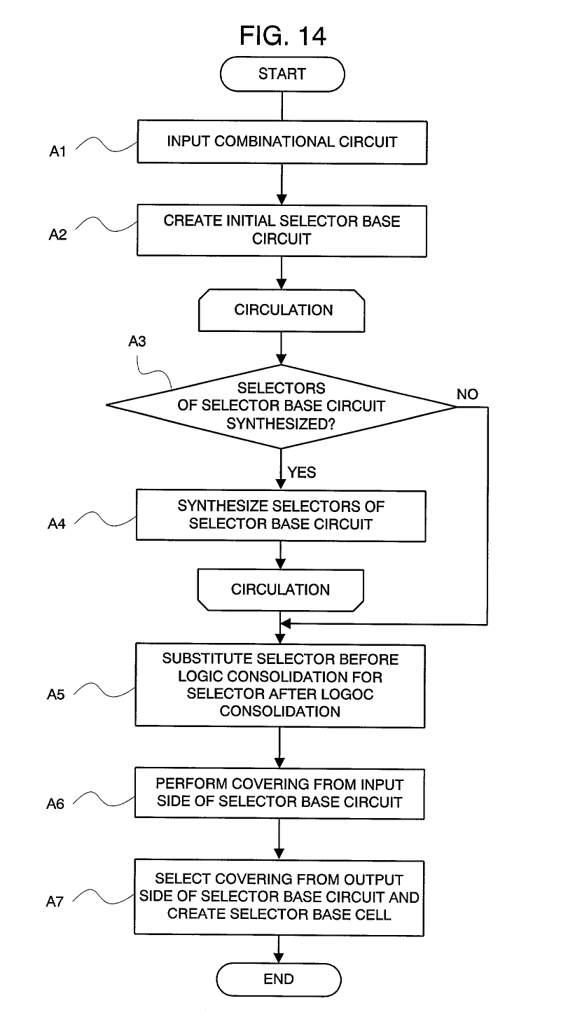

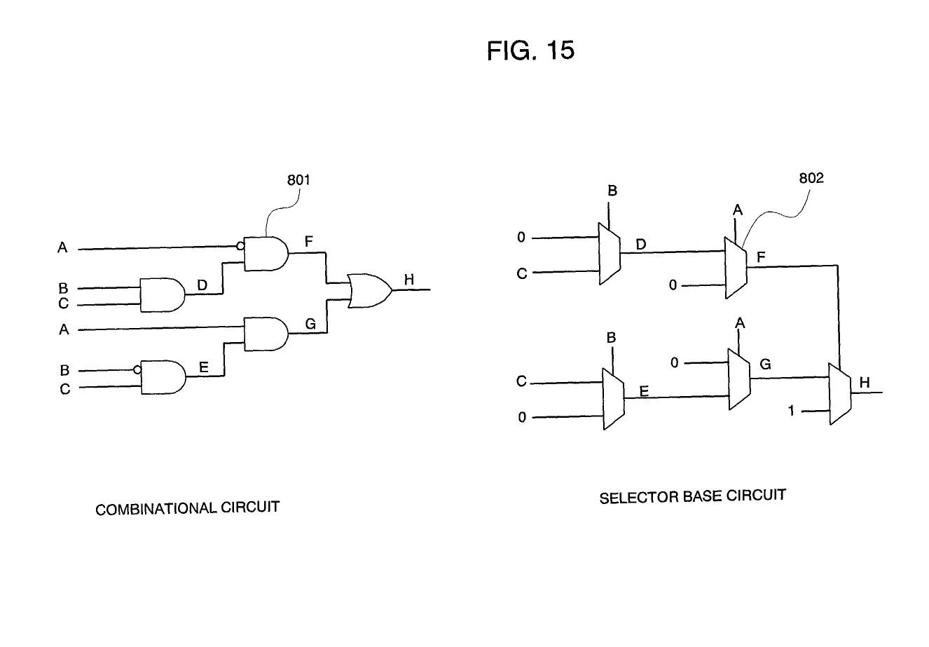

FIG. 14 is a flowchart explaining the operation of the present embodiment. FIGS. 15, 16, 17, and 18 are diagrams each explaining the operation of the present embodiment. When a combinational circuit to be mapped is input from the input device 501, the controller 508 controls the circuit memory 502 to store the combinational circuit into the circuit memory 502 (Step A1). The circuit memory 502 holds the combinational circuit until all the steps are ended.

The controller 508 controls the selector base circuit creator 503 in such a way that all gate logic such as AND logic and OR logic, being gate logical factors, among gate logical factors and wiring factors of the combinational circuit from the circuit memory 502 are transformed into the selector logic to create a selector base circuit.

For example, as shown in FIG. 15, the selector base circuit creator 503 executes the following operation to transform an AND gate into a selector:

(1) creates the selector 802;

(2) connects the data line A being one input of the AND gate 801 to the select line of the selector 802;

(3) when a signal of 0 is input to the data line A and to the select line of the selector 802, the selector base circuit creator 503 connects the data line D to the selected data line; and

(4) when a signal of 1 is input to the data line A and to the select line of the selector 802, the selector base circuit creator 503 connects the data line with the constant of 0 to the data line to be selected when a signal of 1 is input to the select line of the selector 802.

The controller 508 stores the selector base circuit as the initial selector base circuit created by the selector base circuit creator 503 into the selector base memory 504 (Step A2).

The controller 508 controls the selector base circuit modifier 505 to retrieve the selectors which can be synthesized within the selector base circuit from the selector base circuit memory 504 (Step A3).

When the corresponding selectors are retrieved, the selector base circuit modifier 505 synthesizes the selectors.

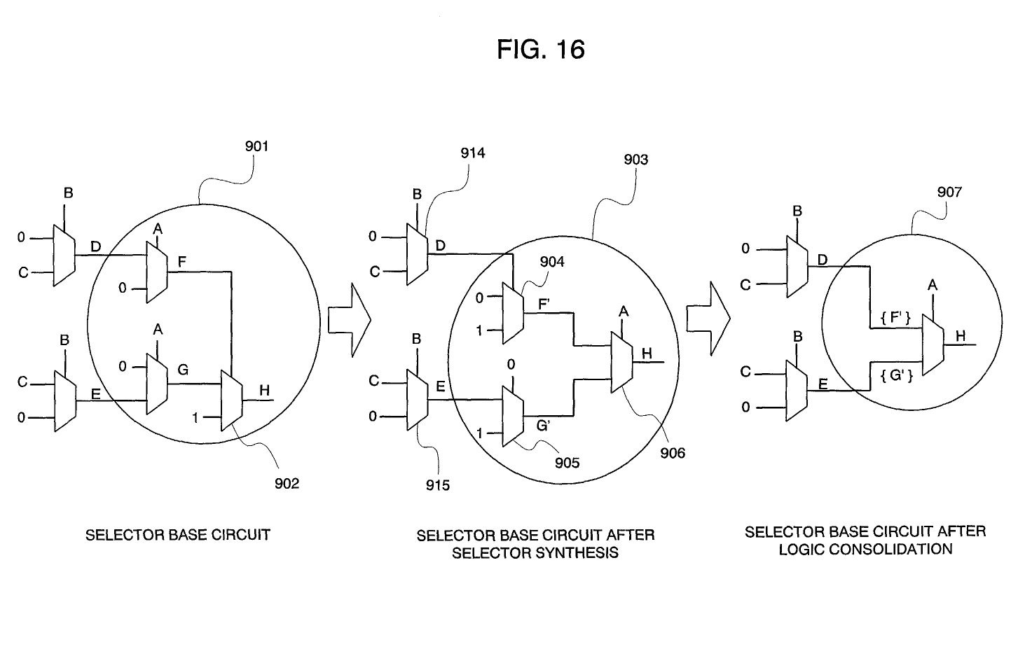

For example, as shown in FIG. 16, when the select line of a selector connected to the select line F of the selector 902 and the select line of a selector connected to the data input line G of the selector 902 correspond to the select line A, the selector base circuit modifier 505 operates as follows:

(1) when a signal of 0 is input to the select line A, the data line D is connected to the select line 1 of the selector 902 and both the data line with a constant of 0 and the data line with a constant of 1 are connected to the data line of the selector 902; and

(2) when a signal of 1 is input to the select line A, the data line with a constant of 0 is connected to the select line of the selector 902 and both the data line E and the data line of a constant of 1 are connected to the data line E of the selector 902.

Thus, the selectors 904 and 905 are created from the selector group 901. The selector 906 is created on the output sides of the selectors 904 and 905. That is, the selector group 901 becomes the selector group 903. Since the data line of a constant of 0 of the data line of a constant of 1 are connected to the data line of the selector 904, the output signal of the selector 904 is identical to the output line D of the selector 914. Thus the logic consolidation can be accomplished. Similarly, since the data line of a constant of 0 is connected to the select line of the selector 905, the output signal of the selector 905 is the same as that from the output line E of the selector 915. As a result, the logic consolidation can be accomplished. This logic consolidation results in making the selector group 907 (Step A4).

Thereafter, until selectors within the selector base circuit cannot be synthesized, the selector synthesis is repeated (Steps A3 and A4).

When the selectors which can be synthesized are not retrieved among selectors within the selector base circuit, the selector base circuit modifier 505 ends the selector transform process of the selector base circuit.

The controller 508 substitutes the selector before logic consolidation in the selector base circuit stored in the selector base circuit memory 504 for the selector after logic consolidation. For example, as shown in FIG. 13, when the selector group 604 is logically consolidated to the selector 605, only the selector group 604 is substituted for the selector 601, without changing other selectors (Step A5).

The mapping cellulating unit 506 performs the covering from the input side of the selector base circuit read out from the selector base circuit memory 504 (Step A5).

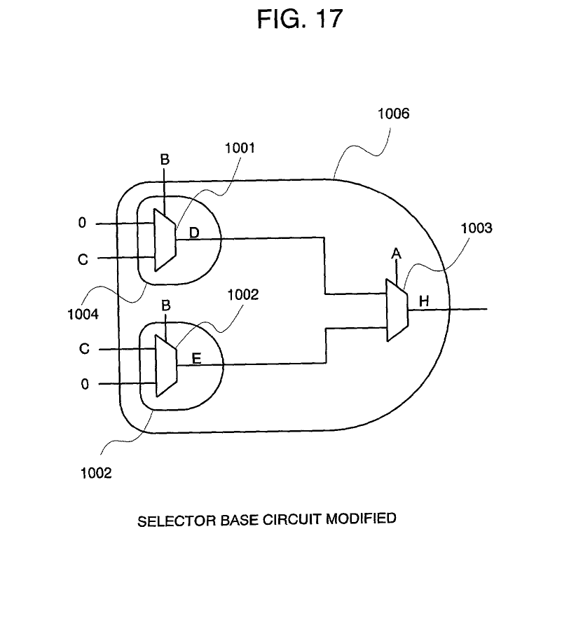

For example, there are no selectors on the input side of each of the selectors 1001 and 1002, as shown in FIG. 17. The selector 1001 acts as the covering 1004 and the selector 1002 acts as the covering 1005. The selectors 1001 and 1002 are on the input side of the selector 1003. Each of the selectors 1001 and 1002 has the same select line B. Hence, the covering 1006 is performed with the three selectors 1001, 1002 and 1003 (Step A6).

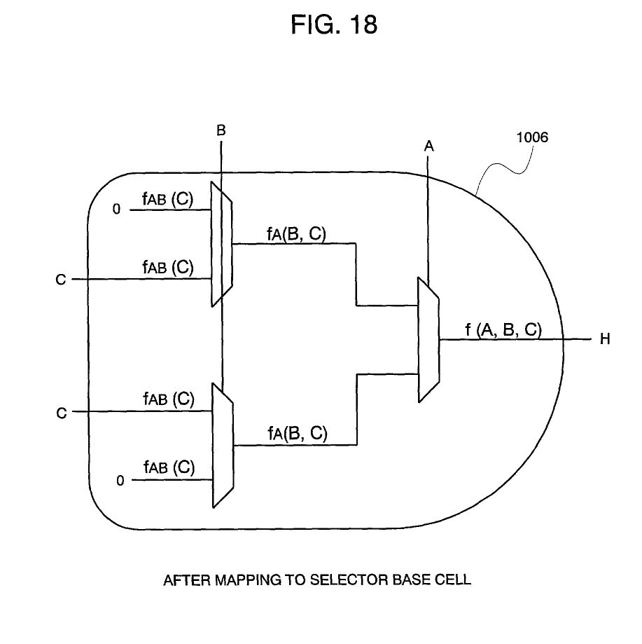

After performing the covering from the input side of the selector base circuit every selector, the mapping cellulating unit 506 selects optimum covering from the output side of the selector base circuit and creates the selector base cell every selected covering. For example, as shown in FIG. 18, the mapping cellulating unit 506 selects the covering 1006 including the selector 1003 having as the self output signal line the output signal line (H) of the selector base circuit and then creates a selector base cell from the selected covering 1006. Since there are no selectors to be selected on the input side of the covering 1006, the mapping cellulating unit 506 ends the creation of the selector base cell.

The controller 508 outputs as the mapping result the selector base cell created by the mapping cellulating unit 506 to the output device 507 (Step A7).

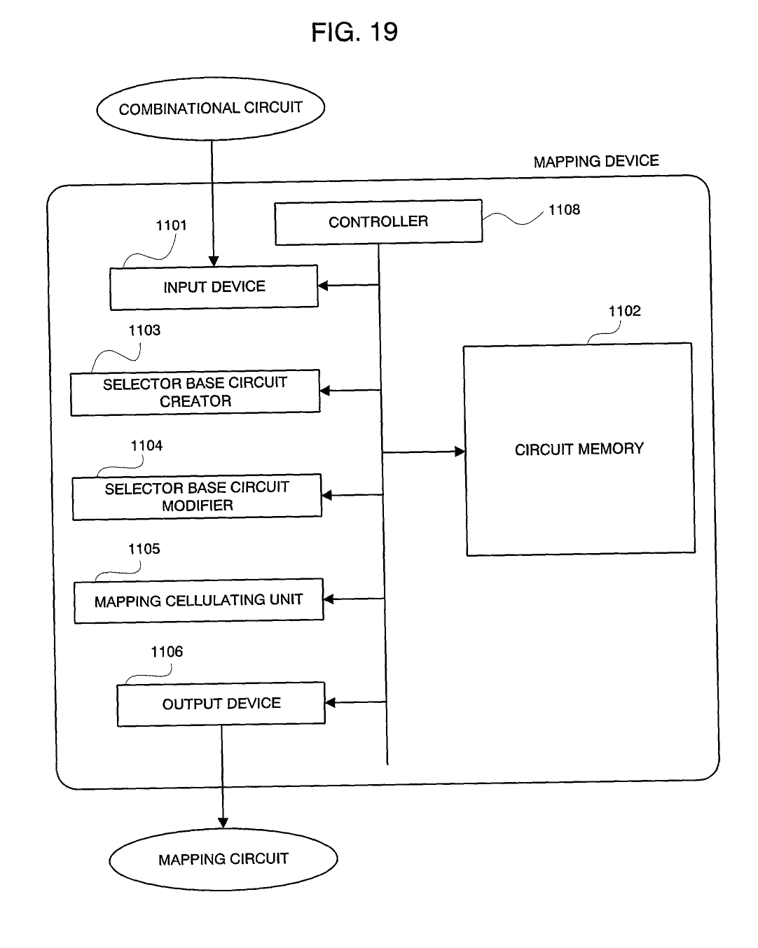

In this embodiment, the above-mentioned configuration has memories two types including the circuit memory 502 and the selector base circuit memory 504. However, as shown in FIG. 19, both the circuit memory 502 and the selector base circuit memory 504 may be integrated as the same circuit memory 1102. For example, the circuit memory 1102 temporarily stores the circuit input by the input device 1101. The selector base circuit creator 1103 transforms the gates of a combinational circuit read out from the circuit memory 1102 into a selector base circuit. Then, the controller 1108 again stores the transformed selector base circuit into the circuit memory 1102. In this case, the combinational circuit initially stored is erased and only the selector base circuit newly stored remains.

A second embodiment will be explained below.

The selector base circuit mapping device in the first embodiment may be realized by a computer control such as a digital signal processor.

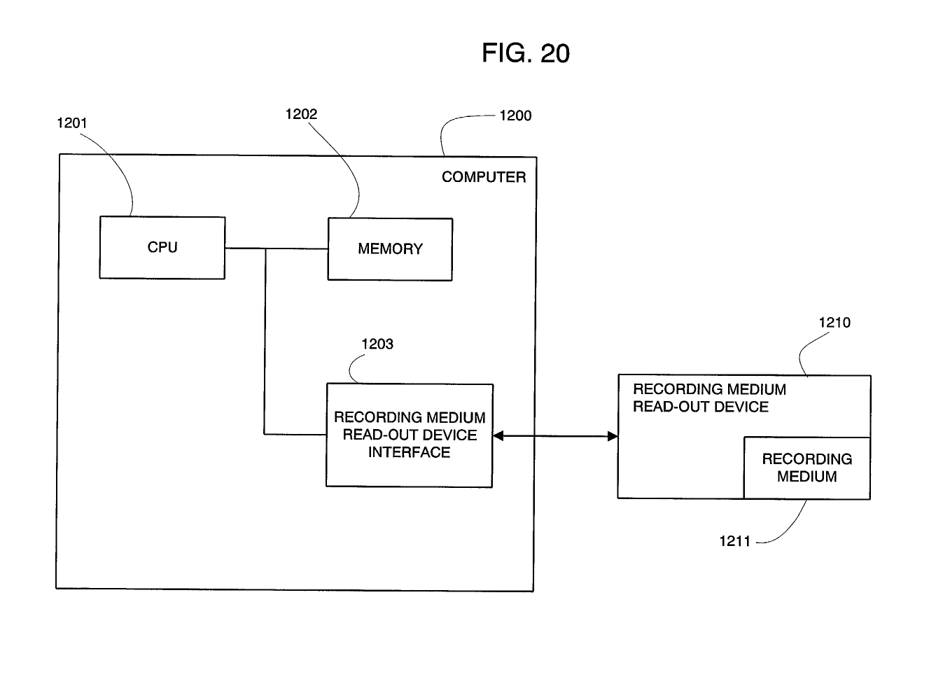

FIG. 20 is a schematic diagram illustrating the configuration of realizing a selector base circuit mapping device realized by a computer.

The computer 1200 executes a program read out from the recording medium 1211. In order to implement logic consolidation by transforming a combinational circuit into a selector base circuit and to create a selector base cell from the logically-consolidated selector base circuit, the recording medium 1211 stores the following program to be executed by the computer 1200. The program comprises the steps of:

(a) selecting gates, except the selector, from a combinational circuit and converting the selected gates into a selector, thus transforming the combinational circuit into a selector base circuit;

(b) storing the converted selector base circuit;

(c) retriving selectors that can be synthesized within the stored selector base circuit and synthesizing the retrieved selectors to logically consolidate them;

(d) substituting the retrieved selector of the stored selector base circuit for the logically-consolidated selector; and

(e) mapping the stored and transformed selector base circuit to a selector base cell.

The program is read out from the recording medium 1211 to the memory 1202 via the recording medium read-out device 1210 and the recording medium read-out device interface 1203 and is executed. The program may be stored into a nonvolatile memory such as a mask ROM or a flash memory. Moreover, the recording medium may be a CD-ROM, FD, DVD (Digital Versatile Disk), MT (Magnetic Tape), or a portable HDD. For example, a computer may convey the program from a server through a cable or wireless communications medium.

Next, the operation in the above-mentioned process will be explained below.

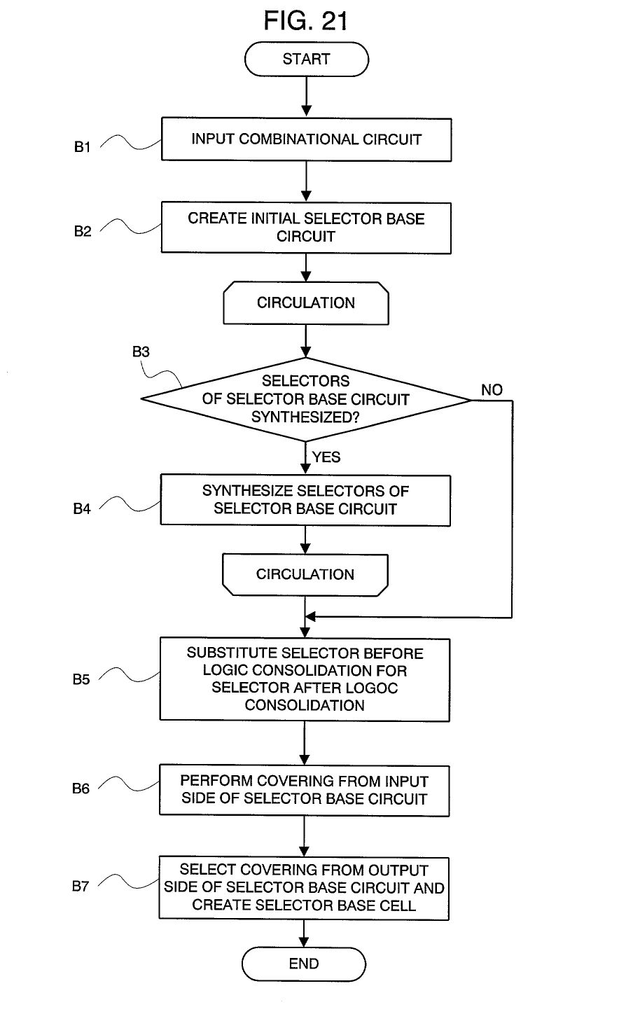

FIG. 21 is a flowchart explaining the operation of the present embodiment.

When receiving a combinational circuit to be mapped, the computer 1200 stores it into the recording medium 1211 (Step B1).

Of gate logical factors and wiring logical factors of a combinational circuit from the recording medium 1211, the computer 1200 creates a selector base circuit obtained by transforming all gate logic such as AND logic and OR logic being a gate logical factor, into selector logic.

For example, when an AND gate is transformed into a selector, as shown in FIG. 15, the computer 1200 performs the following operations.

(1) The computer 1200 creates the selector 802.

(2) The computer 1200 connects the data line A, being one input, of the AND gate 801 to the select line of the selector 802.

(3) When a signal of 0 is input to the data line A, the computer 1200 connects the data line D to the data line selected when a signal of 0 is input to the select line of the selector 802.

(4) When a signal of 1 is input to the data line A, the computer 1200 connects the data line of the constant 0 to the data line selected when a signal of 1 is input to the select line of the selector 802.

After storing the created selector base circuit as an initial selector base circuit into the recording medium 1211 (Step B2), the computer 1200 retrieves selectors that can be synthesized within the created selector base circuit (Step B3).

When the selectors that can be synthesized within the selector base circuit are retrieved, the selector synthesis is performed.

For example, as shown in FIG. 16, both the select line of a selector connected to the select line F of the selector 902 and the select line of a selector connected to the data input line G of the selector 902 are the select line A, the computer 1200 operates as follows:

(1) when a signal of 0 is input to the select line A, the computer 1200 connects the data line D to the select line of the selector 902 and connects the data line of the constant 0 and the data line of the constant 1 to the data line of the selector 902; and

(2) when a signal of 1 is input to the select line A, the computer 1200 connects the data line of the constant 0 to the select line of the selector 902 and connects the data line of the constant 1 to the data line E of the selector 902.

Thus, the selectors 904 and 905 are created from the selector group 901. The selector 906 is created on the output sides of the selectors 904 and 905. That is, the selector group 901 becomes the selector group 903. The data line of the constant 0 and the data line of the constant 1 are connected to the data line of the selector 904. Hence, the output signal of the selector 904 is the same as the signal from the output line D of the selector 914 so that logic consolidation can be performed. Similarly, since the data line of the constant 0 is connected to the select line of the selector 905, the output signal of the selector 905 becomes the signal of the output line E of the selector 915. As a result, logic consolidation can be established. In this logic consolidation, the logically-consolidated selector group becomes the selector group 907 (Step B4).

Thereafter, the selector synthesis is repeated until selectors cannot be synthesized within the selector base circuit (Steps B3 and B4).

When selectors that can be synthesized within the selector base circuit cannot be retrieved, the computer 1200 ends transforming the selector base circuit to a selector.

The computer 1200 substitutes a selector before logic consolidation of the selector base circuit stored in the recording medium 1211 for a selector after logic consolidation. For example, when the selector group 604 is logically consolidated to the selector 605, as shown in FIG. 13, only the selector group 604 is substituted for the selector 601, without changing selectors except the selector group 604 (Step B5).

The computer 1200 implements covering from the input side of a selector base circuit read out from the recording medium 1211.

For example, there are no selectors on the input side of the selectors 1001 and 1002, as shown in FIG. 17. Hence, the selector 1001 becomes the covering 1004 and the selector 1002 becomes the covering 1005. The selectors 1001 and 1002 are on the input side of the selector 1003. The selectors 1001 and 1002 have the same selector line B. Hence, the covering 1006 is performed with three selectors 1001, 1002 and 1003 (Step B6).

After the covering is performed every selector from the input side of the selector base circuit, the computer 1220 selects optimum covering from the output side of the selector base circuit and creates a selector base cell every selected covering. For example, as shown in FIG. 18, the computer 1220 selects the covering 1006 including selectors 1003 having the output signal line (H) of the selector base circuit as a self output signal line and creates a selector base cell from the selected covering 1006. Because there are no selectors to be selected on the input side of the covering 1006, the computer 1200 ends creating selector base cells (Step B7).

The total number of cells after mapping can be reduced. The reason is that synthesizing selectors within a selector base circuit allows the logic consolidation.

Moreover, the present invention enables a high-rate mapping process. The reason is that mapping to a selector base cell of one type that by which arbitrary three input logic is expressible enables a simplified process.

The entire disclosure of Japanese Application No. 2001-040664 filed on Feb. 16, 2001 including specification, claims, drawings and summary are incorporated herein by reference in its entirely.

What is claimed is:

1 A mapping device with logic consolidation function, wherein a combinational circuit is logically transformed into a selector base circuit, comprising:
a transformer for extracting a gate except a selector from a combinational circuit and converting the extracted gate into a selector, thus transforming said combinational circuit into a selector base circuit;
a memory for storing said selector base circuit transformed;
a logic consolidator for implementing logic consolidation by reading out a selector base circuit from said memory, by retrieving selectors which can be synthesized within said selector base circuit read out, and by synthesizing said retrieved selectors;
means for substituting said retrieved selector within a selector base circuit stored in said memory for said logically-consolidated selector; and
a mapper for reading out a selector base circuit after substitution stored in said memory and mapping said readout selector base circuit to said selector base cell.

2 The mapping device defined in claim 1, wherein said logic consolidator comprises:
means for deciding, when a selector is synthesized by selectors within a selector base circuit, whether or not a select line of a selector connected to a select line of a predetermined selector is the same as a select line of a selector connected to a data line of said predetermined selector, and synthesizing, when said two select lines are the same, said predetermined selector with a selector connected to an input side of said selector.

3 The mapping device defined in claim 1, wherein said selector base cell comprises a selector base cell of a type by which arbitrary three-input logic is expressible.

4 A mapping device with logic consolidation function, wherein a combinational circuit is logically synthesized into a selector base circuit, comprising:
a transformer for extracting a gate except a selector from a combinational circuit and converting the extracted gate into a selector, thus transforming said combinational circuit into a selector base circuit;
a logic consolidator for implementing logic consolidation by retrieving selectors which can be synthesized within said selector base circuit and synthesizing said retrieved selectors; and
a mapper for mapping said logically-consolidated selector base circuit to a selector base cell.

5 The mapping device defined in claim 4, wherein said logic consolidator comprises:
means for deciding, when a selector is synthesized by selectors within a selector base circuit, whether or not a select line of a selector connected to a select line of a predetermined selector is the same as a select line of a selector connected to a data line of said predetermined selector, and synthesizing, when said two select lines are the same, said predetermined selector with a selector connected to an input side of said selector.

6 The mapping device defined in claim 4, wherein said selector base cell comprises a selector base cell of a type by which arbitrary three-input logic is expressible.

7 A mapping method with logic consolidation function, wherein a combinational circuit is logically transformed into a selector base circuit, comprising steps of:
selecting a gate, except a selector, from a combinational circuit and converting the selected gate into a selector, thus converting said combinational circuit into a selector base circuit;
storing said selector base circuit transformed;
implementing logic consolidation by retrieving selectors which can be synthesized within said selector base circuit stored and by synthesizing said retrieved selectors;
substituting said retrieved selector within a selector base circuit stored in said memory for said logically-consolidated selector; and
mapping said selector base circuit after substitution stored to said selector base cell.

8 The mapping method defined in claim 7, wherein said selector base cell comprises a selector base cell of a type by which arbitrary three-input logic is expressible.

9 The mapping method defined in claim 7, wherein said logic consolidating step comprises the steps of:
deciding, when a selector is synthesized by selectors within a selector base circuit, whether or not a select line of a selector connected to a select line of a predetermined selector is the same as a select line of a selector connected to a data line of said predetermined selector; and
synthesizing, when said two select lines are the same, said predetermined selector with a selector connected to a n input side of said selector.

10 A mapping method with logical reduction function, wherein a combinational circuit is logically synthesized into a selector base circuit, comprising the steps of:
selecting a gate, except a selector, from a combinational circuit and converting said extracted gate into a selector, thus transforming a combinational circuit into a selector base circuit;
implementing logic consolidation by retrieving selectors which can be synthesized within said selector base circuit and by synthesizing said retrieved selectors; and
mapping said logically-consolidated selector base circuit to a selector base cell.

11 The mapping method defined in claim 10, wherein said selector base cell comprises a selector base cell of a type by which arbitrary three-input logic is expressible.

12 The mapping method defined in claim 10, wherein said logic consolidating step comprises the steps of:
deciding, when a selector is synthesized by selectors within a selector base circuit, whether or not a select line of a selector connected to a select line of a predetermined selector is the same as a select line of a selector connected to a data line of said predetermined selector; and
synthesizing, when said two select lines are the same, said predetermined selector with a selector connected to an input side of said selector.

13 A program for executing, to an information processor that constitutes a mapping device with logic consolidation function, said mapping device logically transforming a combinational circuit into a selector base circuit, the steps of:
selecting a gate, except a selector, from a combinational circuit and converting the selected gate into a selector, thus transforming said combinational circuit into a selector base circuit;
storing said selector base circuit transformed;
implementing logic consolidation by retrieving selectors which can be synthesized within said selector base circuit stored and by synthesizing said retrieved selectors;
substituting said retrieved selector with a selector base circuit stored in said memory for said logically-consolidated selector; and
mapping said stored selector base circuit to said selector base cell.

14 The program defined in claim 13, wherein said selector base cell comprises a selector base cell of a type by which arbitrary three-input logic is expressible.

15 The program defined in claim 13, wherein said logic consolidating step comprises the steps of:
deciding, when a selector is synthesized by selectors within a selector base circuit, whether or not a select line of a selector connected to a select line of a predetermined selector is the same as a select line of a selector connected to a data line of said predetermined selector; and
synthesizing, when said two select lines are the same, said predetermined selector with a selector connected to an input side of said selector.

16 A program for executing, to an information processor that constitutes a mapping device with logic consolidation function, said mapping device logically transforming a combinational circuit into a selector base circuit, the steps of:
selecting a gate, except a selector, from a combinational circuit and converting said selected gate into a selector, thus transforming a combinational circuit into a selector base circuit;
implementing logic consolidation by retrieving selectors which can be synthesized within said selector base circuit and by synthesizing said retrieved selectors; and
mapping said logically-consolidated selector base circuit to a selector base cell.

17 The program defined in claim 16, wherein said selector base cell comprises a selector base cell of a type by which arbitrary three-input logic is expressible.

18 The program defined in claim 16, wherein said logic consolidating step comprises the steps of:
deciding, when a selector is synthesized by selectors within a selector base circuit, whether or not a select line of a selector connected to a select line of a predetermined selector is the same as a select line of a selector connected to a data line of said predetermined selector; and
synthesizing, when said two select lines are the same, said predetermined selector with a selector connected to an input side of said selector.

19 A recording medium wherein a program is stored, said program for executing, to an information processor that constitutes a mapping device with logic consolidation function, said mapping device logically transforming a combinational circuit into a selector base circuit, the steps of:
selecting a gate, except a selector, from a combinational circuit and converting the selected gate into a selector, thus transforming said combinational circuit into a selector base circuit;
storing said selector base circuit transformed;
implementing logic consolidation by retrieving selectors which can be synthesized within said selector base circuit stored, and by synthesizing said retrieved selectors;
substituting said retrieved selector with a selector base circuit stored in said memory for said logically-consolidated selector; and
mapping said stored selector base circuit to said selector base cell.

20 The recording medium defined in claim 19, wherein said selector base cell comprises a selector base cell of a type by which arbitrary three-input logic is expressible.

21 The recording medium defined in claim 19, wherein said logic consolidating step comprises the steps of:
deciding, when a selector is synthesized by selectors within a selector base circuit, whether or not a select line of a selector connected to a select line of a predetermined selector is the same as a select line of a selector connected to a data line of said predetermined selector; and
synthesizing, when said two select lines are the same, said predetermined selector with a selector connected to an input side of said selector.

22 A recording medium wherein a program is stored, said program for executing, to an information processor that constitutes a mapping device with logic consolidation function, said mapping device logically transforming a combinational circuit into a selector base circuit, the steps of:
selecting a gate, except a selector, from a combinational circuit and converting said selected gate into a selector, thus transforming a combinational circuit into a selector base circuit;
implementing logic consolidation by retrieving selectors which can be synthesized within said selector base circuit and by synthesizing said retrieved selectors; and
mapping said logically-consolidated selector base circuit to a selector base cell.

23 The recording medium defined in claim 22, wherein said selector base cell comprises a selector base cell of a type by which arbitrary three-input logic is expressible.

24 The recording medium defined in claim 22, wherein said logic consolidating step comprises the steps of:
deciding, when a selector is synthesized by selectors within a selector base circuit, whether or not a select line of a selector connected to a select line of a predetermined selector is the same as a select line of a selector connected to a data line of said predetermined selector; and
synthesizing, when said two select lines are the same, said predetermined selector with a selector connected to an input side of said selector.
